(19) United States
(12) Patent Application Publication
(10) Pub. No.: US 2022/0275143 A1
(43) Pub. Date: Sep. 1, 2022

(54) COMPOSITION FOR FORMING BIODEGRADABLE HORTICULTURAL GROWING FOAM

(71) Applicant: BABYFOAM UK LTD, London (GB)

(72) Inventor: Chun-Hao LU, Taipei City (TW)

(21) Appl. No.: 17/643,519

(22) Filed: Dec. 9, 2021

(30) Foreign Application Priority Data
Mar. 1, 2021 (GB) 2102873.3

(51) Int. Cl. C08G 18/48; C08G 18/73; C08G 18/64; A01G 24/22; A01G 24/48

(52) U.S. Cl. CPC C08G 18/4891; C08G 18/73; C08G 18/6484; A01G 24/22; A01G 24/48; C08G 2101/00

(57) ABSTRACT

A composition for forming a biodegradable horticultural growing foam includes a vegetable oil-based polyol, an aliphatic isocyanate, an alkyl polyglucoside, a foaming agent including an aqueous metal carbonate solution, and a biomass. Based on 100 parts by weight of the vegetable oil-based polyol, the aliphatic isocyanate, alkyl polyglucoside, aqueous metal carbonate solution, and biomass are respectively present in amounts ranging from 20 to 75 parts by weight, ranging from 2 to 27 parts by weight, ranging from 1 to 6 parts by weight, and of at least 20 parts by weight. A biodegradable horticultural growing foam prepared by the composition is also disclosed.

### CROSS-REFERENCE TO RELATED APPLICATION

This application claims priority of UK Patent Application No. 2102873.3, filed on Mar. 1, 2021.

### FIELD

The disclosure relates to a composition for forming a biodegradable horticultural growing foam.

### BACKGROUND

Polyurethane foams are produced by reacting a di- or polyisocyanate with a polyol, generally in the presence of catalysts, silicone-based surfactants, and other auxiliary agents. Polyurethane foams have a large number of applications including: cushions for bedding (such as mattresses and topper pads), padding for underlying carpets, gaskets for a variety of uses, textile laminates, horticultural growing media for plant nutrition, growth and support, and energy absorbing materials. However, polyurethane foams are not readily biodegradable and cannot be decomposed by a composting process, thereby polluting water and environment.

Chinese Invention Patent Publication No. 110964161 A discloses a bio-based hydrophilic foam which is prepared from: a composition A including 45 to 60 parts of a bio-based polyol I, 10 to 30 parts of a bio-based polyol II, 10 to 20 parts of a bio-based polyol III, 0 to 10 parts of an active material, 0.5 to 2 parts of a silane, 0.2 to 0.7 part of an amine catalyst, and 1.5 to 5 parts of water; and a composition B including 26 to 42 parts of a bio-based isocyanate. The amine catalyst can be triethylenediamine or a delayed-action catalyst.

Chinese Invention Patent Publication No. 102276782 A discloses a natural vegetable oil-based horticultural growing foam which is prepared from a combined material and isocyanate, wherein the combined material comprises the following components by weight: 100 parts of a composite polyatomic alcohol, 0 to 8 parts of a cross-linking agent or a chain extender, 0 to 3 parts of a composite catalyst, 0 to 4 parts of a foam stabilizer, 0.2 to 10 parts of a foaming agent, and 0 to 50 parts of a filler.

The composite catalyst can be bis-2-(dimethylamino)ethyl)ether, pentamethyldiethylenetriamine, N, N-dimethylcyclohexylamine, or triethylene diamine. The foam stabilizer can be a silicone surfactant, such as Niax™ Silicone L-580, TEGOSTAB® B 8681, and TEGOSTAB® B 8444.

In spite of the aforesaid, there is still a need to develop an environmental-friendly biodegradable horticultural growing foam that contains no irritative amine catalyst and silicone oil which are harmful to the environment.

### SUMMARY

Accordingly, in a first aspect, the present disclosure provides a composition for forming a biodegradable horticultural growing foam, including:
a vegetable oil-based polyol;
an aliphatic isocyanate which is present in an amount ranging from 20 to 75 parts by weight, based on 100 parts by weight of the vegetable oil-based polyol;
an alkyl polyglucoside (APG) which is present in an amount ranging from 2 to 27 parts by weight, based on 100 parts by weight of the vegetable oil-based polyol;
a foaming agent including an aqueous metal carbonate solution which is present in an amount ranging from 1 to 6 parts by weight, based on 100 parts by weight of the vegetable oil-based polyol; and
a biomass which is contained in an amount of at least 20 parts by weight, based on 100 parts by weight of the vegetable oil-based polyol.

In a second aspect, the present disclosure provides a biodegradable horticultural growing foam which is prepared by a composition as described above.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some aspects ±100%, in some aspects ±50%, in some aspects ±20%, in some aspects ±10%, in some aspects ±5%, in some aspects ±1%, in some aspects ±0.5%, and in some aspects ±0.1% from the specified amount, as such variations are appropriate to perform the disclosed methods or employ the disclosed compositions.

As used herein, the terms “biodegradable” and “compostable” can be used interchangeably, and refer to any organic material, composition, compound, or polymer, which may be broken down into organic substances or compost by living organisms, for example, microorganisms.

The present disclosure provides a composition for forming a biodegradable horticultural growing foam, including:
a vegetable oil-based polyol;
an aliphatic isocyanate which is present in an amount ranging from 20 to 75 parts by weight, based on 100 parts by weight of the vegetable oil-based polyol;
an alkyl polyglucoside (APG) which is present in an amount ranging from 2 to 27 parts by weight, based on 100 parts by weight of the vegetable oil-based polyol;
a foaming agent including an aqueous metal carbonate solution which is present in an amount ranging from 1 to 6 parts by weight, based on 100 parts by weight of the vegetable oil-based polyol; and

a biomass which is contained in an amount of at least 20 parts by weight, based on 100 parts by weight of the vegetable oil-based polyol.

According to the present disclosure, the vegetable oil-based polyol may be selected from the group consisting of a soybean oil-based polyol, a palm oil-based polyol, a castor oil-based polyol, and combinations thereof.

According to the present disclosure, the vegetable oil-based polyol has a weight average molecular weight ranging from 600 g/mole to 7000 g/mole.

According to the present disclosure, the aliphatic isocyanate may be selected from the group consisting of 1,4-butanediisocyanate (BDI), 1,6-hexamethylene diisocyanate (HDI), 2,2,4-trimethyl hexamethylene diisocyanate (TMDI), ethyl 2,6-diisocyanatohexanoate (ELDI), methyl 2,6-diisocyanatohexanoate (MLDI), isophorone diisocyanate (IPDI), 1,4-cyclohexane diisocyanate (CHDI), and combinations thereof. In an exemplary embodiment, the aliphatic isocyanate is HDI.

In certain embodiments, the alkyl polyglucoside is present in an amount ranging from 4 to 9 parts by weight, based on 100 parts by weight of the vegetable oil-based polyol.

According to the present disclosure, the alkyl polyglucoside may be selected from the group consisting of PLANTACARE6 810 UP, PLANTACAREO 1200 UP, PLANTACARE® 2000 UP, and combinations thereof. In certain embodiments, the alkyl polyglucoside is PLANTACARE® 2000 UP.

According to the present disclosure, the aqueous metal carbonate solution includes a metal carbonate and water in a weight ratio of the metal carbonate to water ranging from 1:100 to 50:100.

According to the present disclosure, the metal carbonate may be selected from the group consisting of potassium carbonate, sodium carbonate, and combinations thereof.

According to the present disclosure, the biomass may be present in an amount ranging from 50 to 150 parts by weight, based on 100 parts by weight of the vegetable oil-based polyol.

According to the present disclosure, the biomass may be selected from the group consisting of coffee grounds, eggshells, mung bean dregs, soybean dregs, tea powders, multipurpose compost, coconut coir, and combinations thereof. In an exemplary embodiment, the biomass is coffee grounds.

According to the present disclosure, the composition may further include urea.

According to the present disclosure, urea may be present in an amount ranging from 0.1 to 6 parts by weight, based on 100 parts by weight of the vegetable oil-based polyol.

According to the present disclosure, the composition may further include a cross-linking agent.

According to the present disclosure, the cross-linking agent is present in an amount ranging from 0.1 to 12 parts by weight, based on 100 parts by weight of the vegetable oil-based polyol.

According to the present disclosure, the cross-linking agent may be selected from the group consisting of glycerol, polyglycerol, ethylene glycol, 1,4-butanediol, diethylene glycol, dipropylene glycol, trihydroxyl propane, polytrimethylolpropane, and combinations thereof.

The present disclosure also provides a biodegradable horticultural growing foam which is prepared by a composition as described above.

The disclosure will be further described by way of the following examples. However, it should be understood that the following examples are solely intended for the purpose of illustration and should not be construed as limiting the disclosure in practice.

### EXAMPLES

### Example 1

100 parts by weight (referred to as “pbw” hereinafter) of a soybean oil-based polyether polyol (HM-10100, Hairma Chemicals (Gz) Co., Ltd) (functionality: 4.5; weight average molecular weight: 2500 g/mole), 51.57 pbw of 1,6-hexamethylene diisocyanate (HDI), 6.26 pbw of an aqueous solution (the weight ratio of water, urea, and potassium carbonate (K₂CO₃) is 100:100:8.67), 6 pbw of an alkyl polyglucoside (APG) (PLANTACARE® 2000 UP, BASF Personal Care and Nutrition GmbH), and 100 pbw of coffee grounds were mixed homogeneously, followed by stirring at 2000 rpm at a temperature of 25° C. for 60 seconds, so as to form an emulsion mixture. The emulsion mixture was poured into a container and was allowed to undergo a foaming reaction for about 130 minutes to obtain a foamed mixture. The foamed mixture was cured at room temperature for 72 hours, so as to obtain a foam material of Example 1.

### Example 2

100 pbw of a soybean oil-based polyether polyol (HM-10100, Hairma Chemicals (Gz) Co., Ltd.) (functionality: 4.5; weight average molecular weight: 2500 g/mole), 51.47 pbw of HDI, 0.2 pbw of glycerine (serving as a cross-linking agent), 4.5 pbw of an aqueous K₂CO₃ solution (serving as a foaming agent, the weight ratio of water and K₂CO₃ is 100:12.5), 7 pbw of an alkyl polyglucoside (APG) (PLANTACARE® 2000 UP, BASF Personal Care and Nutrition GmbH), 68 pbw of coffee grounds, and 32 pbw of coconut coir were mixed homogeneously, followed by stirring at 2000 rpm at a temperature of 25° C. for 60 seconds, so as to form an emulsion mixture. The emulsion mixture was poured into a container and then was allowed to undergo a foaming reaction for about 115 minutes to obtain a foamed mixture. The foamed mixture was cured at room temperature for 72 hours, so as to obtain a foam material of Example 2.

### Comparative Example 1

100 pbw of a soybean oil-based polyether polyol (HM-10100, Hairma Chemicals (Gz) Co., Ltd.) (functionality: 4.5; weight average molecular weight: 2500 g/mole), 44.05 pbw of HDI, 0.2 pbw of an amine catalyst (Niax* Catalyst A-33, Momentive Performance Materials Inc.), 6 pbw of an alkyl polyglucoside (APG) (PLANTACARE® 2000 UP, BASF Personal Care and Nutrition GmbH), and 3 pbw of water were mixed homogeneously, followed by stirring at 2000 rpm at a temperature of 25° C. for 60 seconds, so as to form an emulsion mixture. The emulsion mixture was allowed to undergo a foaming reaction in a condition as described in Example 1. It was observed that the foam material thus obtained was deformed and collapsed.

### Comparative Example 2

100 pbw of a soybean oil-based polyether polyol (HM-10100, Hairma Chemicals (Gz) Co., Ltd.) (functionality: 4.5; weight average molecular weight: 2500 g/mole), 52.34 pbw of HDI, 3 pbw of glycerine (serving as a cross-linking agent), 6.12 pbw of an aqueous solution (the weight ratio of water, urea, and K₂CO₃ is 100:100:4), and 0.6 pbw of silicone oil (TEGOSTA®: B 8474) were mixed homogeneously, followed by stirring at 2000 rpm at a temperature of 25° C. for 60 seconds, so as to form an emulsion mixture. The emulsion mixture was poured into a container and then was allowed to undergo a foaming reaction for about 99 minutes to obtain a foamed mixture. The foamed mixture was cured at room temperature for 72 hours. It was observed that the foam material thus obtained was a high density solid block.

### Comparative Example 3

100 pbw of a soybean oil-based polyether polyol (HM-10100, Hairma Chemicals (Gz) Co., Ltd.) (functionality: 4.5; weight average molecular weight: 2500 g/mole), 51.56 pbw of HDI, 6 pbw of an aqueous urea solution (the weight ratio of water and urea is 1:1), and 6 pbw of an alkyl polyglucoside (APG) (PLANTACARE@ 2000 UP, BASF Personal Care and Nutrition GmbH) were mixed homogeneously, followed by stirring at 2000 rpm at a temperature of 25° C. for 60 seconds, so as to form an emulsion mixture. The emulsion mixture was allowed to undergo a foaming reaction in a condition as described in Example 1. It was observed that the foam material thus obtained was deformed and collapsed.

### Comparative Example 4

100 pbw of a soybean oil-based polyether polyol (HM-10100, Hairma Chemicals (Gz) Co., Ltd.) (functionality: 4.5; weight average molecular weight: 2500 g/mole), 38.42 pbw of HDI, 0.2 pbw of an amine catalyst (Niax* Catalyst A-33, Momentive Performance Materials Inc.), 0.6 pbw of silicone oil (TEGOSTAB® B 8474), and 3 pbw of water were mixed homogeneously, followed by stirring at 2000 rpm at a temperature of 25° C. for 60 seconds, so as to form an emulsion mixture. The emulsion mixture was allowed to undergo a foaming reaction in a condition as described in Example 1. It was observed that the foam material thus obtained was deformed and collapsed.

The components and the amounts thereof for making the foam materials of Examples 1 and 2 and Comparative Examples 1 to 4 are summarized in Table 1 below.

TABLE 1

| | | | Comparative | Comparative | Comparative | Comparative |
|---|---|---|---|---|---|---|
| | Example 1 | Example 2 | Example 1 | Example 2 | Example 3 | Example 4 |
| | Amount (pbw) | | | | | |
| Soybean oil-based | 100 | 100 | 100 | 100 | 100 | 100 |
| polyether polyol | | | | | | |
| 1,6-hexamethylene | 51.57 | 51.47 | 44.05 | 52.34 | 51.56 | 38.42 |
| diisocyanate (HDI) | | | | | | |
| Glycerine | — | 0.2 | — | 3 | — | — |
| Aqueous urea | — | — | — | — | 6 (Urea:H₂O = | — |
| solution | | | | | 1:1) | |
| Aqueous K₂CO₃ | — | 4.5 (H₂O:K₂CO₃ = | — | — | — | — |
| solution | | 100:12.5) | | | | |
| Aqueous solution | 6.26 (H₂O:urea:K₂CO₃ = | — | — | 6.12 (H₂O:urea:K₂CO₃ = | — | — |
| containing urea | 100:100:8.67) | | | 100:100:4) | | |
| and K₂CO₃ | | | | | | |
| Amine catalyst (Niax* | — | — | 0.2 | — | — | 0.2 |
| Catalyst A-33) | | | | | | |
| Silicone oil | — | — | — | 0.6 | — | 0.6 |
| (TEGOSTAB ® B | | | | | | |
| 8474) | | | | | | |
| Alkyl polyglucoside | 6 | 7 | 6 | — | 6 | — |
| (PLANTACARE ® | | | | | | |
| 2000 UP) | | | | | | |
| Water | — | — | 3 | — | — | 3 |
| Biomass | 100 (Coffee | 100 (Coffee | — | — | — | — |
| | grounds) | grounds:coconut | | | | |
| | | coir = 68:32) | | | | |

### Property Evaluation:

### A. Measurement of Biomass Content

The amounts of biobased carbon-14 (¹⁴C) and total organic carbon in the foam materials of Examples 1 and 2 and Comparative Examples 1 to 4 were measured according to ASTM D6866.

The biomass content (%) was calculated using the following Equation (I):

A=B/C (I)

where A=biomass content (%)
B=amount of biobased ¹⁴C of respective foam material (g)
C=amount of total organic carbon of respective foam material (g)

### B. Biodegradation Test

The foam materials of Examples 1 and 2 and Comparative Example 2 were respectively buried in soil at a depth of 20 cm, and the ambient temperature was greater than 25° C. After 6 months, each foam material was taken out and the weight loss was measured.

The degree of biodegradation (%) was calculated using the following Equation (II):

D=(E−F)/E (II)

where D=degree of biodegradation (%)
E=weight of foam material of Example 1, Example 2 or Comparative Example 2 before the test (g)
F=weight of foam material of Example 1, Example 2 or Comparative Example 2 after the test (g)

### Results:

The results of the property evaluation are shown in Table 2. It can be seen from Table 2 that the biomass contents determined in the foam materials of Examples 1 and 2 were higher than those determined in the foam materials of Comparative Examples 1 to 4.

In addition, the degrees of biodegradation determined in the foam materials of Examples 1 and 2 were significantly higher than that determined in the foam material of Comparative Example 2.

These results indicate that the foam material of the present disclosure is biodegradable and can break down naturally, so that it does not present environmental problems, and hence can be used as a horticultural growing and support medium.

TABLE 2

| | Biomass | Degree of |
|---|---|---|
| | content (%) | biodegradation (%) |
| Example 1 | 81 | 75 |
| Example 2 | 81 | 71 |
| Comparative Example 1 | 71 | Not determined* |
| Comparative Example 2 | 67 | 33 |
| Comparative Example 3 | 68 | Not determined* |
| Comparative Example 4 | 73 | Not determined* |

*due to deformation and collapse

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

What is claimed is:

1. A composition for forming a biodegradable horticultural growing foam, comprising:
a vegetable oil-based polyol;
an aliphatic isocyanate which is present in an amount ranging from 20 to 75 parts by weight, based on 100 parts by weight of the vegetable oil-based polyol;
an alkyl polyglucoside (APG) which is present in an amount ranging from 2 to 27 parts by weight, based on 100 parts by weight of the vegetable oil-based polyol;
a foaming agent including an aqueous metal carbonate solution which is present in an amount ranging from 1 to 6 parts by weight, based on 100 parts by weight of the vegetable oil-based polyol; and
a biomass which is contained in an amount of at least 20 parts by weight, based on 100 parts by weight of the vegetable oil-based polyol.

2. The composition according to claim 1, wherein the vegetable oil-based polyol is selected from the group consisting of a soybean oil-based polyol, a palm oil-based polyol, a castor oil-based polyol, and combinations thereof.

3. The composition according to claim 1, wherein the vegetable oil-based polyol has a weight average molecular weight ranging from 600 g/mole to 7000 g/mole.

4. The composition according to claim 1, wherein the aliphatic isocyanate is selected from the group consisting of 1,4-butanediisocyanate (BDI), 1,6-hexamethylene diisocyanate (HDI), 2,2,4-trimethyl hexamethylene diisocyanate (TMDI), ethyl 2,6-diisocyanatohexanoate (ELDI), methyl 2,6-diisocyanatohexanoate (MLDI), isophorone diisocyanate (IPDI), 1,4-cyclohexane diisocyanate (CHDI), and combinations thereof.

5. The composition according to claim 1, wherein the aqueous metal carbonate solution includes a metal carbonate and water in a weight ratio of the metal carbonate to water ranging from 1:100 to 50:100.

6. The composition according to claim 1, wherein the biomass is present in an amount ranging from 50 to 150 parts by weight, based on 100 parts by weight of the vegetable oil-based polyol.

7. The composition according to claim 1, wherein the biomass is selected from the group consisting of coffee grounds, eggshells, mung bean dregs, soybean dregs, tea powders, multipurpose compost, coconut coir, and combinations thereof.

8. The composition according to claim 1, further comprising urea.

9. The composition according to claim 8, wherein urea is present in an amount ranging from 0.1 to 6 parts by weight, based on 100 parts by weight of the vegetable oil-based polyol.

10. The composition according to claim 1, further comprising a cross-linking agent.

11. The composition according to claim 10, wherein the cross-linking agent is present in an amount ranging from 0.1 to 12 parts by weight, based on 100 parts by weight of the vegetable oil-based polyol.

12. The composition according to claim 10, wherein the cross-linking agent is selected from the group consisting of glycerol, polyglycerol, ethylene glycol, 1,4-butanediol, diethylene glycol, dipropylene glycol, trihydroxyl propane, polytrimethylolpropane, and combinations thereof.

13. A biodegradable horticultural growing foam prepared by the composition according to claim 1.
